(19) United States
(12) Patent Application Publication
(10) Pub. No.: US 2011/0267464 A1
(43) Pub. Date: Nov. 3, 2011

(54) REMOTE TELEMETRY AND VIDEO

(75) Inventors: Danny Peter Archer, New South Wales (AU); Bradley Wilton Scott, New South Wales (AU)

(73) Assignee: RMTEK PTY LTD, Amidale NSW (AU)

(21) Appl. No.: 12/995,128

(22) PCT Filed: May 14, 2009
(86) PCT No.: PCT/AU2009/000599

§ 371 Date: Mar. 18, 2011

(30) Foreign Application Priority Data
May 28, 2008 (AU) 2008902687

(51) Int. Cl. H04N 7/18; H04N 7/173; H04H 20/71

(52) U.S. Cl. 348/143; 455/3.03; 725/114; 348/E07.085

(57) ABSTRACT

This invention concerns remote telemetry and video. In a first aspect, the invention is a remote telemetry and video support platform for communicating with at least one remote mobile telemetry video monitoring installation, and with users. The platform stores a profile for each remote installation and uses this profile to assemble a message for transmission to each remote installation to enable automatic configuration of the remote installation's hardware, and establishment of a monitoring regime. Thereafter as the monitoring regime is performed by the remote installation and monitoring data is generated, the server platform receives, stores and interprets the data, and provides the data to users as required and according to the respective profile. In another aspect a remote mobile telemetry and video monitoring installation. In a further aspect the invention is a remote telemetry and video network comprising the platform and plural remote installations.

### TECHNICAL FIELD

This invention concerns remote telemetry and video. In a first aspect, the invention is a remote telemetry and video support platform, and in another aspect a remote mobile telemetry and video monitoring installation. In a further aspect the invention is a remote telemetry and video network comprising the platform and plural remote installations.

### DISCLOSURE OF THE INVENTION

In a first aspect, the invention is a telemetry and video support computer platform for communicating with at least one remote mobile telemetry video monitoring installation, and with users. Wherein, the platform stores a profile for each remote installation and uses this profile to assemble a message for transmission to each remote installation to enable automatic configuration of the remote installation's hardware, and establishment of a monitoring regime. Thereafter as the monitoring regime is performed by the remote installation and monitoring data is generated, the server platform receives, stores and interprets the data, and provides the data to users as required and according to the respective profile.

The platform may comprise one or more clusters of servers, which may be distributed. The clusters may include:
A relational database management system cluster.
A device Real-Time Services cluster.
A device Data Logging cluster.
A web application server cluster. And,
Further external applications.

A user can log in to the platform via the Internet to set up the hardware in a remote installation and establish a monitoring regime. The set up will take account of the equipment at the remote installation. The user's instructions are recorded in a profile with is stored at the platform in the relational database system. The server makes available appropriate instructions, from the profile, to a remote installation that responds by setting itself up and establishing the regime.

The user can retrieve the data from archive at the platform for viewing at any convenient time. The stored profile is used to reconstruct the data for proper display to the user. The user may view real time images being generated by the remote installation. Other possibilities include the data stream being compacted and made available in a machine readable form. This allows third party developers to use data and services to create specialist applications.

In another aspect the invention is a remote mobile telemetry and video monitoring installation, comprising:

An Internet Protocol IP video camera integrated with an embedded control processor.
A communications port.
A modem.
A network interface.
A radio transceiver. And,
An antenna,

Wherein, the installation receives and executes commands to set up its hardware and establish a monitoring regime in a form determined by the commands, and then performs the regime and transmits data, including image data and associated metadata about the images.

The remote installations may automatically connect themselves to the platform via a communications network. As the regime is performed data, including images, are returned to the platform where they are archived. The communications network link may remain in continuous communication if required so that real time imagery and control services are available.

Sound, motion, vibration and other transducers may be included at a remote installation and the set up will take account of this in the profile so that the data from these transducers is properly labelled and handled. Provision may be made for additional devices to be added over time.

The transducers may be used to trigger alarms. For instance, a noise may trigger the remote installation to begin a surveillance patrol. Alternatively, or in addition, an alarm message may be sent to the server, or directly to the user. Or may push a message or an alarm to another device or application for the purpose of notification to end users. Any convenient mode of communications may be used, including SMS or email directly to the user.

The remote installations may be operated by solar power or other renewable sources, and may be designed to operate effectively on a supply voltage in the range of 12 to 240 volts. The remote installations may be easily moved from place-to-place.

Individual users may have zero, one or more remote installations associated with themselves; however an installation will only have one owner associated with it. The owner may however delegate rights to another user or group in a predefined “privilege relationship”.

Importantly, a user may develop relationships with other users of a “one to one” or “one to many”, or “one to select” nature and by doing this have the ability to share all or some of the functionality of a remote installation with those in their “social network”. This means that a device owner can assign rights to other users for one, some or all functions that are available.

In a further aspect the invention is a method for setting up the hardware for a remote mobile telemetry and video monitoring installation and establishing a monitoring regime, comprising the steps of:
Creating a user selected profile for the remote installation.
Transmitting the profile to the remote installation.
Automatically using the profile at the remote installation to configure the remote installation's hardware, and establish a monitoring regime.
Thereafter as the monitoring regime is performed by the remote installation and monitoring data is generated, transmitting the data to a server platform according to the profile.

In a further aspect the invention is a remote telemetry and video network comprising the platform and plural remote installations.

### BRIEF DESCRIPTION OF THE DRAWINGS

An example of the invention will now be described with reference to the accompanying drawings, in which:

FIG. 1 is a block diagram of a remote telemetry and video network.

FIG. 2 is a diagram of a typical remote installation.

FIG. 3 is a diagram of a typical remote installation profile.

FIG. 4 is a screenshot of data, including image data, presented to a user.

### BEST MODES OF THE INVENTION

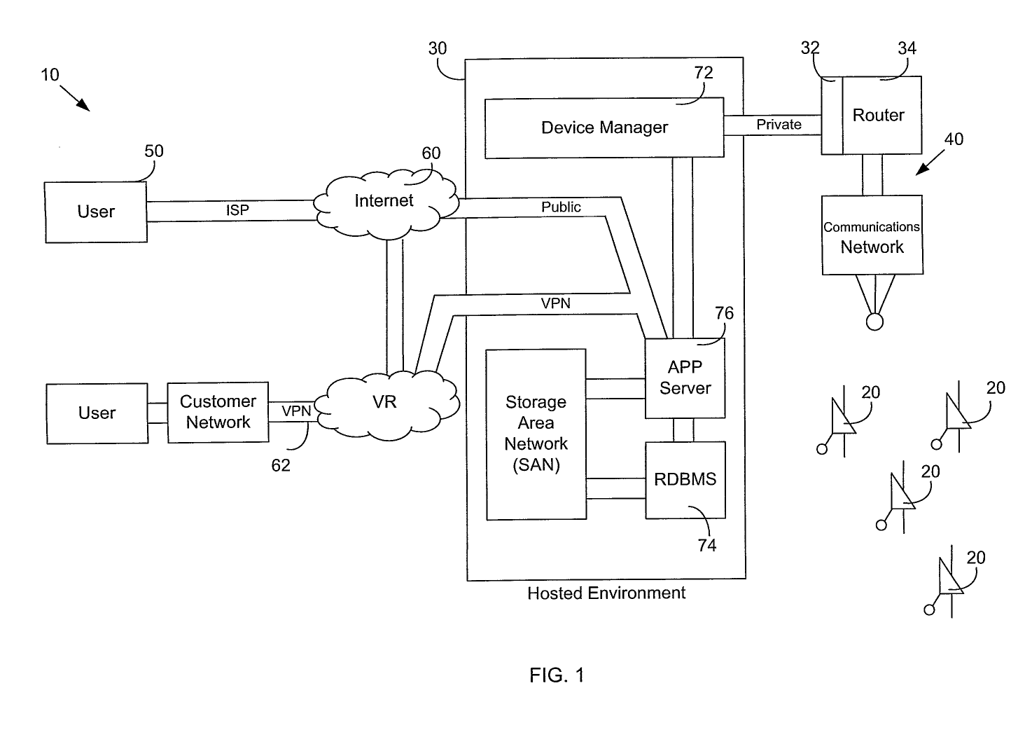

Referring first to FIG. 1, the remote telemetry and video monitoring network 10 comprises at least one remote telemetry and mobile video monitoring installation 20, and at least one telemetry and video support platform 30 in communication with each other through the agency of a communications network 40. Users employ remote computers 50 and access the platform 30, for instance using standard browsers via the Internet 60.

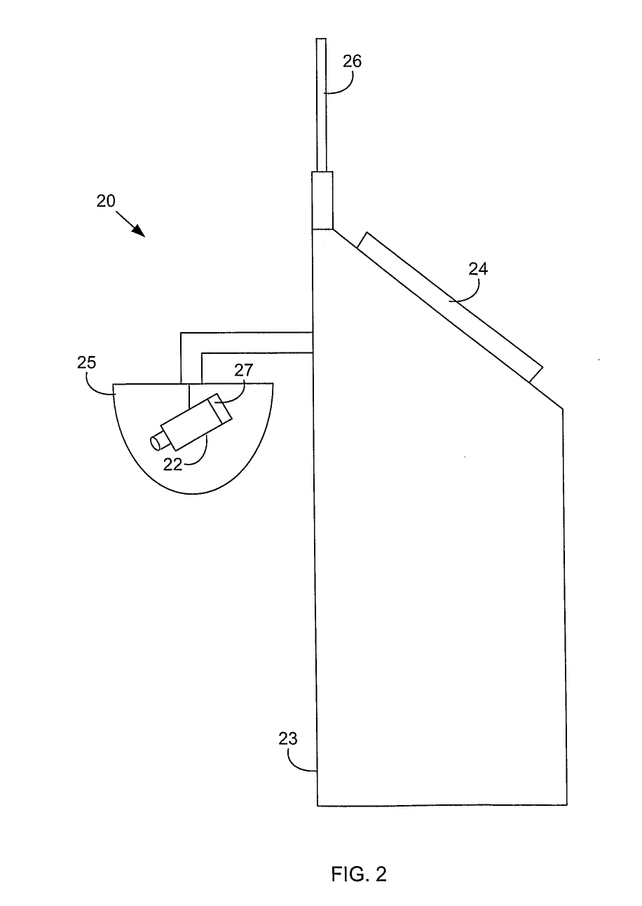

The platform 30 will now be described in more detail; the remote installations 20 will be described in greater detail later with respect to FIG. 2. The platform 30 is connected to the communications network 40 via a firewall 32 and router 34. Communications with the Internet 60 and client VPN's 62 are via a further firewall and router (not shown).

The platform 30 includes a device manager 72, database 74 and web application server 76, and is supported by a storage area network. The platform 30 may be distributed across many geographically distinct hosts. The platform 30 is responsible for:
Networking users' computers 50 and remote installations 20.
Allowing users to customise set up of remote installations 20.
Setting up and reconfiguring remote installations 20.
Providing application program interfaces (API's).
Receiving, storing and presenting data from remote installations 20.
Interpreting images, data and metadata.

The device manager 72 in particular is responsible for:
Maintaining communications with remote installations 20.
Simultaneously managing many remote installations 20.
Locating remote installations 20 on the network.
Tracking the configuration of the remote installations 20.
Providing live images and switching services.
Updating software for remote installations 20.

The device manager 72 communicates with the remote installations 20 over a communications network 40. The device manger also comprises a remote installation controller, and a web application, that resides on application sever 76 to serve the user's Internet interfaces and a web front-end HTML+JS+FLASH.

The device manager 72 provides live viewing services, so that live imagery can be displayed by the web application to users. It also configures cameras at the remote installations to respond to inputs, issue outputs, and set timed events including periodic image captures. It also collects data that is automatically collected by deployed sensors. It receives images captured on a schedule, receives images triggered by deployed sensor input, as well as data collected by the deployed sensors. It also passes collected information to the database and sends signals onto deployed sensors and to control remote equipment.

Referring now to FIG. 2, the remote installations 20 comprise a weatherproof, vented cabinet 23 with an angled top having a solar panel 24 mounted on it. The cabinet also has a weatherproof camera dome 25 capable of being mounted to the unit, and an external mount for an antenna 26. Inside the camera dome is a high quality IP video camera 22, an E State Automation Pty Ltd, Cell Visor embedded controller 27 which provides the communications link from the camera 22 to the antenna 26. Transmission to and from the device manager 72 is effected making use of communications network 40 and does not necessarily require any wired communications infrastructure.

The IP video camera 22 includes pan, tilt and zoom capability. In combination with the controller 27, it can store a large number of preset positions and can perform routine preset patrols for image collection at allocated time intervals. The resulting images can be stored for review in image gallery, as a movie or subscribed to as images or as a movie in machine readable form.

The cabinet 23 has a rear opening door and there is enough space inside the cabinet to hold an battery and associated wiring loom, a regulator and wiring break-out board. The cabinet 23 has provision for mounting onto a pole or other rigid structure.

The camera installations 20 can be set up to communicate wirelessly with deployed sensors, such as PIR motion sensors, IR light sensors, weather stations, scientific data loggers, bar code readers, weight scales, irrigation sensors and RFID readers. Also, electric fence levels, rainfall gauges, water pressure, soil moisture and pH sensors. Line of sight communications links are suitable between these sensors and the camera installation, and the camera is able to keep items up to four kilometres away under video surveillance. The installations may also be equipped with a GPS module for georeference position determination.

Event driven alarm functions, set up to respond to signals received from one or more remote sensors, will cause the camera to start taking pictures and send samples to the user via the server or directly by MMS or email. Alternatively, an SMS or email can be sent to invite the user to log in to the system.

The remote installations 20 are also set up to control remote equipment wirelessly, such as gate openers, water pumps and lighting.

When a new remote installation 20 is commissioned, the user selects the equipment that will be installed and the location for the installation. Then the user is then able to access the platform 30 over the Internet to set up the remote installation, by for instance:
Determining a monitoring regime for the camera, such as the times or frequency at which the camera will capture images at preset pan, zoom and tilt settings.
Define alerts and alarm events from sensor input or image processing.
Define image archiving and image delivery mechanisms.

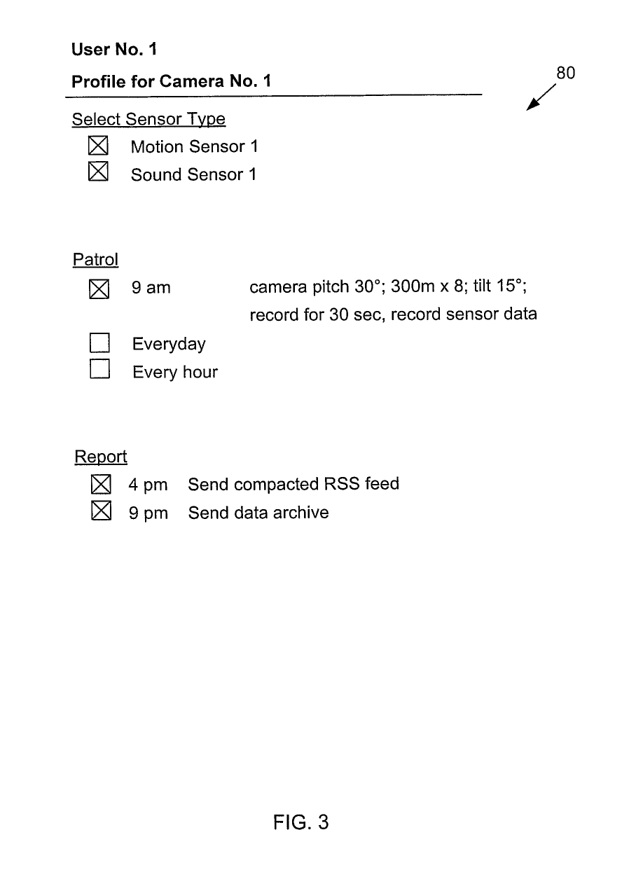

All these settings are recorded at the platform 30 in a remote installation profile 80, see an example in FIG. 3. The device manager 72 stores the profile 80 in database 74, and constructs a set up message for the remote installation containing information from the profile 80.

The profile 80 stored at the camera platform is downloaded to the remote installation 20 at set up time. Upon receipt the installation sets itself up and begins execution of the patrolling regime.

According to this profile, the images for each pre-set camera position are combined into a down-sampled, compressed, time lapsed movie, on a daily basis, that will be provided automatically to the client in a machine readable form, http viewing, podcast or download to the user's computer.

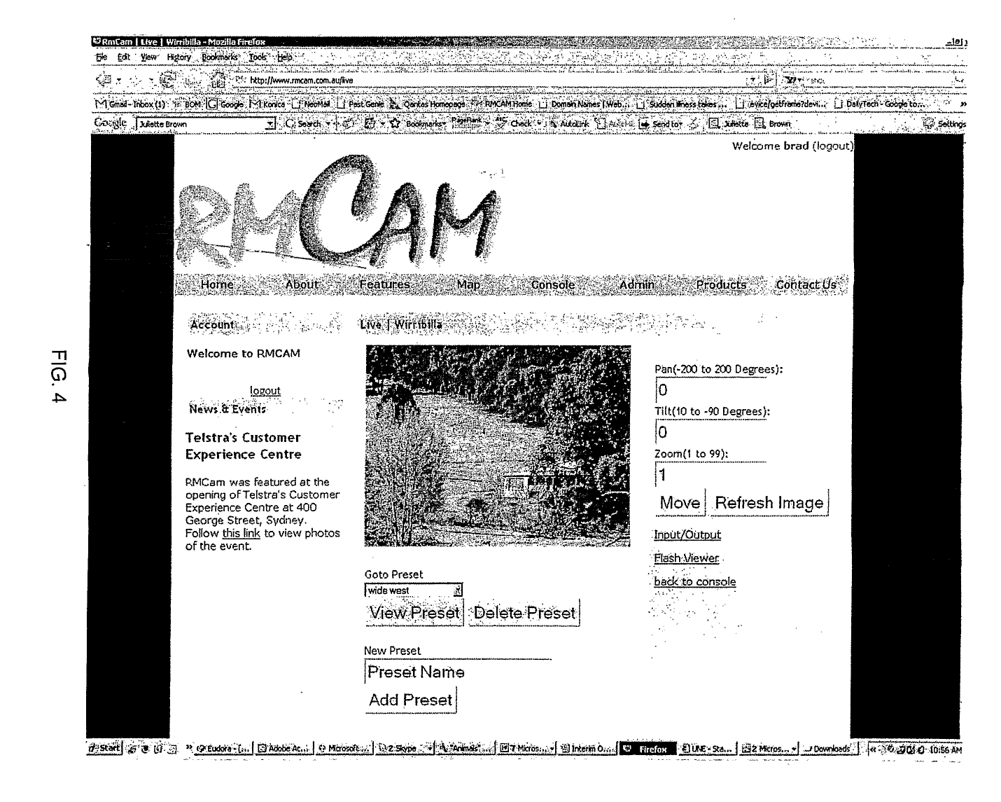

The data, including image data, is also archived to the database 74 according to the profile. All the images are date stamped, and can be digitally signed. The images are filed chronologically, by pre-set position, for later reference on line. When the data is retrieved the profile is used to identify and present each type of data to user intelligibly, see FIG. 4.

In addition, the profile includes SMS or email alerts when a remote sensor indicates an alarm state such as a sensor being triggered unexpectedly. This enables the user to log on and review the image database to review image and/or sensor data.

As well as the profile determined activity, the camera 22 can be controlled in real time by signals transmitted from the device manager 72, and in this mode of operation the camera returns images in the form of CCTV type image data for immediate transmission to the user.

The user is also able to view live imagery on a viewer within http web pages, as well as accessing time or event based galleries of captured images and download stop motion video compositions of galleries. In viewing these movies, if at any point the client needs to examine an image in further detail, they can access the high quality image on their server space on the platform.

The user is also able to control equipment such as gates, lights, pumps, monitoring devices, motors and other assets remotely. The equipment may be controlled through access via an html, javascript and flash interface or via SMS transmitted directly to an address at the camera installation or by API calls issued by a third party Application. The remote infrastructure may be up to 4 km from the camera installation via wireless link.

Although the invention has been described with reference to a particular example, it should be appreciated that it could be exemplified in many other forms and in combination with other features not mentioned above. For instance, mains power may be provided instead of, or in addition to, solar. Also, the users may access the remote installation using a device able to communicate over the Internet, including a mobile phone, PDA or other device capable of web browsing.

The system works primarily in conjunction with cellular wireless systems mobile phone networks. Equally, signals may be transmitted to and from the remote installation via radio networks. A night vision or infra-red capability may be provided to the camera. A WiFi access point on the remote installation may allow wireless Internet connection within line of sight.

1. A telemetry and video support computer platform for communicating with at least one remote mobile telemetry video monitoring installation, and with users; wherein, the platform stores a profile for each remote installation and uses this profile to assemble a message for transmission to each remote installation to enable automatic configuration of the remote installation's hardware, and establishment of a monitoring regime; thereafter as the monitoring regime is performed by the remote installation and monitoring data is generated, the server platform receives, stores and interprets the data, and provides the data to users as required and according to the respective profile.

2. A telemetry and video support computer platform according to claim 1, further comprising one or more of the following clusters of servers:
a relational database management system cluster;
a device Real-Time Services cluster;
a device Data Logging cluster;
a web application server cluster; and,
further external applications.

3. A telemetry and video support computer platform according to claim 2, wherein the clusters of servers are distributed.

4. A remote mobile telemetry and video monitoring installation, comprising:
an Internet Protocol IP video camera integrated with an embedded control processor;
a communications port;
a modem;
a network interface;
a radio transceiver; and,
an antenna;
wherein, the installation receives and executes commands to set up its hardware and establish a monitoring regime in a form determined by the commands, and then performs the regime and transmits data, including image data and associated metadata about the images, wherein the commands are based on a profile associated with the installation.

5. A remote mobile telemetry and video monitoring installation according to claim 4, wherein in use, the installation automatically connects itself to a platform via a communications network.

6. A remote mobile telemetry and video monitoring installation according to claim 5, wherein the communications connection via the network remains in continuous communication so that real time imagery and control services are available.

7. A remote mobile telemetry and video monitoring installation according to claim 4, further comprising one or more of sound, motion, vibration and other transducers.

8. A remote mobile telemetry and video monitoring installation according to claim 7, wherein the transducers are used to trigger alarms.

9. A remote mobile telemetry and video monitoring installation according to claim 4, wherein the remote installations are operated by solar power.

10. A remote mobile telemetry and video monitoring installation according to claim 4, wherein the remote installations are mobile.

11. A remote mobile telemetry and video monitoring installation according to claim 4, wherein the installation is associated with a single owner.

12. A remote mobile telemetry and video monitoring installation according to claim 11, wherein the owner delegate rights to one or more other users.

13. A remote mobile telemetry and video monitoring installation according to claim 12, wherein users may be related with other users in a “one to one” or “one to many”, or “one to select” nature and by doing this the owner has the ability to share all or some of the functionality of a remote installation with those users.

14. A method for setting up the hardware for a remote mobile telemetry and video monitoring installation and establishing a monitoring regime, comprising the steps of:
creating a user selected profile for the remote installation;
transmitting the profile to the remote installation;
automatically using the profile at the remote installation to configure the remote installation's hardware, and establish a monitoring regime;
and, thereafter as the monitoring regime is performed by the remote installation and monitoring data is generated, transmitting the data to a server platform according to the profile.

15. A remote telemetry and video network comprising the platform according to claim 1 having plural remote installations.

16. A remote telemetry and video network according to claim 15, wherein a user logs in to the platform via the Internet to set up the hardware in a remote installation and establish a monitoring regime.

17. A remote telemetry and video network according to claim 16, wherein user's instructions take account of the equipment at the remote installation.

18. A remote telemetry and video network according to claim 17, wherein the user's instructions are recorded in a profile with is stored at the platform.

19. A remote telemetry and video network according to claim 18, wherein the server makes available appropriate instructions, from the profile, to a remote installation that responds by setting itself up and establishing the regime.
